(19) United States
(12) Patent Application Publication
(10) Pub. No.: US 2006/0184761 A1
(43) Pub. Date: Aug. 17, 2006

(54) Identification information diagnosis method and input and output apparatus

(75) Inventors: Hirotaka Shikada, Kawasaki (JP); Hiroki Tashima, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/168,349

(22) Filed: Jun. 29, 2005

(30) Foreign Application Priority Data
Feb. 16, 2005 (JP) 2005-039469

(51) Int. Cl. G06F 12/00

(52) U.S. Cl. 711/170; 711/112

(57) ABSTRACT

An identification information diagnosis method is used in an input and output apparatus in which first identification information unique to each storage unit is written in each storage unit that is inserted into a corresponding slot of each device enclosure, and a physical address of each storage unit is obtained from second identification information unique to each enclosure and the first identification information that is read from each storage unit of a corresponding device enclosure and stored in the corresponding the storage unit. The diagnosis method obtains a regular physical address from prestored first and second identification information, reads the first identification information from the storage unit accessed by the regular physical address, and diagnoses the first identification information read from the storage unit accessed by the regular physical address, based on a diagnosis table.

### BACKGROUND OF THE INVENTION

1. Field of the Invention

The present invention generally relates to identification information diagnosis methods and input and output apparatuses, and more particularly to an identification information diagnosis method for diagnosing identification information of a storage unit that is implemented in an input and output apparatus, and to an input and output apparatus that employs such an identification information diagnosis method.

2. Description of the Related Art

Conventionally, there is an input and output apparatus that has a plurality of device enclosures mounted on a rack, where a plurality of Hard Disk Drives (HDDs) are implemented in each device enclosure. In such an input and output apparatus, the HDDs are inserted into a plurality of slots that are provided in each device enclosure, and a different slot value is set for each HDD. An Arbitrated Loop Physical Address (AL_PA) map is created based on an ID of the device enclosure and the slot value that is read from the HDD when the power is turned ON, for example. The ID of the device enclosure is identification information unique to and indicating each device enclosure. In addition, the slot value is identification information unique to and indicating the position of each slot within each device enclosure. When an access request is received from a host unit, an access is made to a corresponding HDD by referring to the AL_PA map. By using the AL_PA map, it is possible to know the slot and the device enclosure where the corresponding HDD requested by the access request exists.

Within one device enclosure, the slot values of the HDDs that are inserted into the slots are unique. However, among different device enclosures, the slot values of the HDDs that are inserted into the slots may not necessarily be unique. For this reason, every time the power is turned ON, for example, the AL_PA map is created by acquiring slot IDs from the ID of the device enclosure and the slot values of the HDDs that are implemented in this device enclosure. When an access request is received from the host unit, an access is made to a corresponding HDD, that is, a unique address (physical location) corresponding to the HDD, by referring to the AL_PA map.

For example, a Japanese Laid-Open Patent Application No.2004-220265 proposes a type of the input and output apparatus described above.

From a back panel of the device enclosure, a slot position signal corresponding to the slot value is supplied via a connector to the HDD that is inserted into the corresponding slot. When creating the AL_PA map described above, the slot values are read from the HDDs. For this reason, if foreign particles and the like are adhered on the connector and at least a portion (for example, 1 bit) of the slot position signal is blocked by the foreign particles and the like and not supplied to the HDD, a correct slot value cannot be read from the HDD and it is impossible to create a correct AL_PA map that is originally intended. When the correct AL_PA map cannot be created, there was a problem in that it is impossible to correctly access the HDD that is originally intended.

In addition, if the correct slot value cannot be read from the HDD, there is a possibility that the same slot value will be read from two different HDDs that are implemented within one device enclosure, for example. In this case, the HDD that is inserted into the slot where the abnormality is actually generated should be disconnected from the device enclosure, but it is impossible to judge the HDD from which the erroneous slot value is read. Consequently, both the HDDs from which the same slot value is read must be disconnected from the device enclosure, and there was a problem in that it is difficult to efficiently utilize the resources (storage units such as the HDDs).

### SUMMARY OF THE INVENTION

Accordingly, it is a general object of the present invention to provide a novel and useful identification information diagnosis method and input and output apparatus, in which the problems described above are suppressed.

Another and more specific object of the present invention is to provide an identification information diagnosis method and an input and output apparatus, which can specify a storage unit, such as an HDD, from which an erroneous identification information is read, so as to enable a normal access to the storage unit.

Still another object of the present invention is to provide an identification information diagnosis method for an input and output apparatus in which first identification information unique to each of storage units is written in each of the storage units that is inserted into a corresponding one of slots of each of device enclosures, and a physical address of each of the storage units is obtained from second identification information unique to each of the device enclosures and the first identification information that is read from each of the storage units of a corresponding one of the device enclosures and stored in the corresponding one of the storage units, comprising the steps of (a) obtaining a regular physical address from first and second identification information prestored in a memory; (b) reading the first identification information from one of the storage units that is accessed by the regular physical address; and (c) diagnosing the first identification information read from the one of the storage units that is accessed by the regular physical address, based on a diagnosis table that stores the regular physical address and a corresponding regular first identification information. According to the identification information diagnosis method of the present invention, it is possible to specify the storage unit, such as an HDD, from which an erroneous identification information is read, so as to enable a normal access to the storage unit.

A further object of the present invention is to provide an input and output apparatus in which first identification information unique to each of storage units is written in each of the storage units that is inserted into a corresponding one of slots of each of device enclosures, and a physical address of each of the storage units is obtained from second identification information unique to each of the device enclosures and the first identification information that is read from each of the storage units of a corresponding one of the device enclosures and stored in the corresponding one of the storage units, comprising an obtaining part configured to obtain a regular physical address from first and second identification information prestored in a memory; a reading part configured to read the first identification information from one of the storage units that is accessed by the regular physical address; and a diagnosing part configured to diagnose the first identification information read from the one of the storage units that is accessed by the regular physical address, based on a diagnosis table that stores the regular physical address and a corresponding regular first identification information. According to the input and output apparatus of the present invention, it is possible to specify the storage unit, such as an HDD, from which an erroneous identification information is read, so as to enable a normal access to the storage unit.

Other objects and further features of the present invention will be apparent from the following detailed description when read in conjunction with the accompanying drawings.

### BRIEF DESCRIPTION OF THE DRAWINGS

FIG. 1 is a system block diagram showing an important part of an embodiment of an input and output apparatus according to the present invention;

FIG. 2 is a perspective view for explaining insertion of an HDD into a slot;

FIG. 3 is a diagram for explaining a slot ID;

FIG. 4 is a flow chart for explaining an operation when setting a device enclosure ID;

FIG. 5 is a flow chart for explaining an operation when creating a fiber channel map table;

FIG. 6 is a diagram for explaining a cell table and an AL_PA table;

FIG. 7 is a diagram for explaining the fiber channel map table;

FIG. 8 is a flow chart for explaining a normal access operation;

FIG. 9 is a flow chart for explaining a diagnosis operation carried out by a device enclosure;

FIG. 10 is a diagram showing an AL_PA value calculation table; and

FIG. 11 is a flow chart for explaining a diagnosis operation carried out by a RAID controller.

### DESCRIPTION OF THE PREFERRED EMBODIMENTS

A description will be given of embodiments of an identification information diagnosis method and an input and output apparatus according to the present invention, by referring to the drawings.

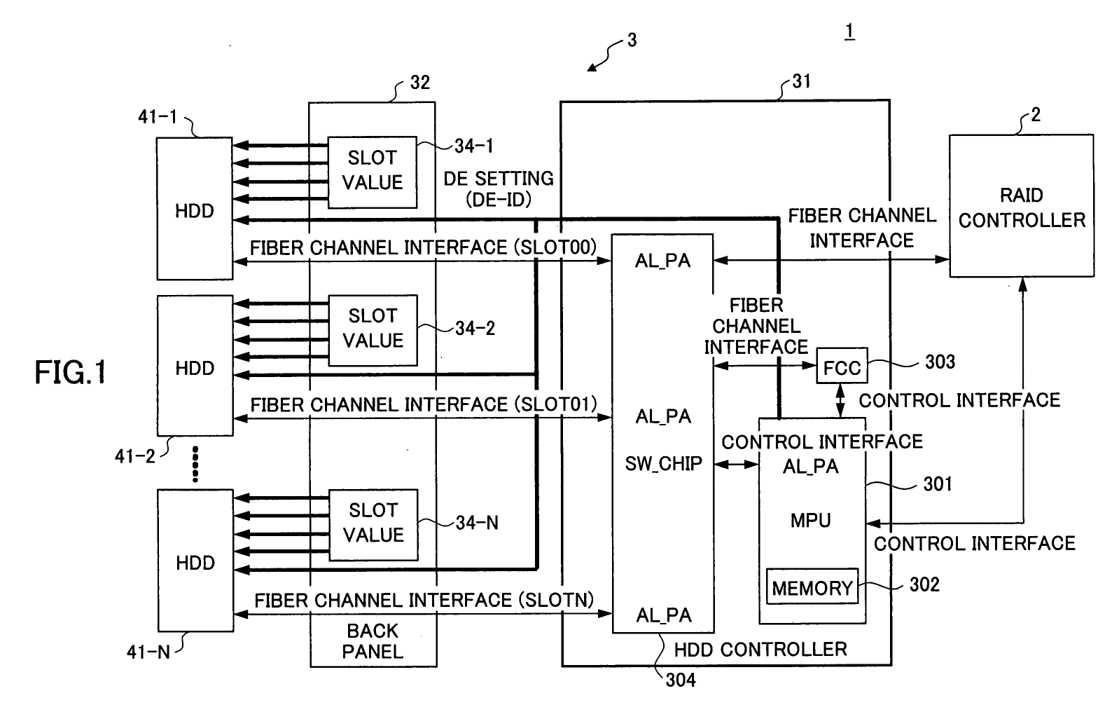

FIG. 1 is a system block diagram showing an important part of an embodiment of the input and output apparatus according to the present invention. This embodiment of the input and output apparatus employs an embodiment of the identification information diagnosis method according to the present invention. In this embodiment, the present invention is applied to an apparatus having a Redundant Arrays of Independent (or Inexpensive) Disks (RAID) structure, but the application of the present invention is not limited to such, and the present invention may of course be applied to apparatuses using storage units other than HDDs.

An input and output apparatus 1 includes a RAID controller 2 and a plurality of device enclosures 3 that are mounted on a rack (not shown), but for the sake of convenience, only one device enclosure 3 is shown in FIG. 1. The device enclosure 3 includes an HDD controller 31 and a back panel 32. HDDs 41-1 through 41-N are inserted into the slots that are provided in the pack panel 32.

The RAID controller 2 carries out a known RAID control, and centrally controls each of the device enclosures 3. The RAID controller 2 has a known structure including a Channel Adaptor (CA), a Centralized Module (CM), a Device Adaptor (DA), a Router (RT) and a Service Controller (SVC). The CA is formed by a module that controls an external interface with respect to a host unit. The CM is formed by a module that manages all operations within the corresponding device enclosures 3, and is provided with a cache memory. The DA is formed by a module that controls an external interface with respect to a subordinate apparatuses, that is, the physical devices (HDDs). The module forming the DA is provided with a 2-port Fiber Channel Arbitrated Loop (FCAL) interface. The RT is formed by a module that forms a communication interface with respect to other RAID controllers.

The HDD controller 31 is formed by a Port Bypass Circuit (PBC) that is made of a switch for Fiber Channel drive connection. The HDD controller 31 includes a MPU 301 that is provided with a memory, register or the like 302 (hereinafter simply referred to as a memory 302) for storing tables and the like which will be described later, a Fiber Channel Controller (FCC) 303, and a Switch-Chip (SW-CHIP) 304. The MPU 301 controls the entire operation of the corresponding device enclosure 3. The FCC 303 monitors the HDDs 41-1 through 41-N within the corresponding device enclosure 3, and is capable of executing a Fiber Channel (FC) command with respect to each of the HDDs 41-1 through 41-N. The SW-CHIP 304 is formed by a IC chip having a Fiber Channel Arbitrated Loop (FCAL) switching function and an AL_PA value acquiring function, and for example, chips SOC312, 320 and 422 manufactured by Emulex and a chip PM8375 manufactured by PMC-SIERRA may be used for the SW-CHIP 304.

Registers 34-1 through 34-N are provided in the pack panel 32 in correspondence with each of the slots. The registers 34-1 through 34-N respectively store slot values (first identification information) that form slot IDs of the corresponding HDDs 41-1 through 41-N. The slot values are fixed with respect to the HDDs 41-1 through 41-N, and each form lower 4 bits of the slot ID, for example. Device enclosure IDs (second identification information) are unique to each of the device enclosures 3. The device enclosure ID is prestored in the memory 302 within the MPU 301 of the HDD controller 31, together with the slot values of the HDDs 41-1 through 41-N that are preset in the registers 34-1 through 34-N of the back panel 32. The device enclosure ID forms upper 3 bits of the slot ID, for example.

The RAID controller 2 and the MPU 301 within the HDD controller 31 are connected via a control interface. The RAID controller 2 and the SW-CHIP 304 within the HDD controller 31 are connected via a Fiber Channel Interface (FCI). Within the HDD controller 31, the MPU 301 and the FCC are connected via a control interface, and the MPU 301 and the SW-CHIP 304 are connected via a control interface. The FCC 303 and the SW-CHIP 304 within the HDD controller 31 are connected via a Fiber Channel Interface (FCI). In addition, the SW-CHIP 304 within the HDD controller 31 and the HDDs 41-1 through 41-N are connected via Fiber Channel Interfaces (FCIs), and the slot values can be read out to the SW-CHIP 304 via the FCIs. Moreover, the MPU 301 and the HDDs 41-1 through 41-N are connected via device enclosure ID setting interfaces, and the device enclosure ID is written to the HDDs 41-1 through 41-N via the device enclosure ID setting interfaces when the power of the device enclosure 3 is turned ON, for example.

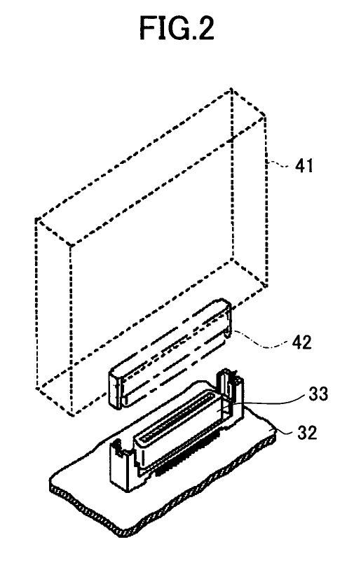

FIG. 2 is a perspective view for explaining the insertion of the HDD into the slot. In FIG. 2, a plurality of slots 33 (only one shown) having a plurality of connection terminals are provided in the back panel 32. The HDD 41 has a connector part 42 that is to be inserted into the slot 33. By inserting the connector part 42 into the slot 33, the connection terminals of the slot 33 and corresponding connection terminals of the connector part 42 are mutually connected. For example, the connector part 42 may be formed by a connector SCA-2 prescribed by EIA-700A0AF (SP-3652), and may conform to signal requirements such as SFF-8451 and SFF-8045.

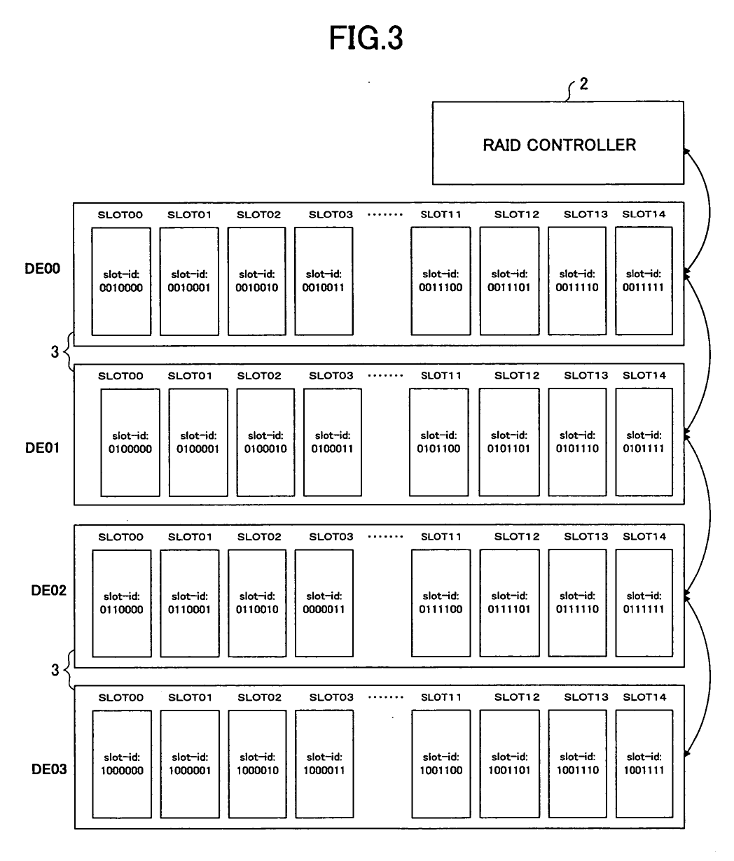

FIG. 3 is a diagram for explaining the slot ID. FIG. 3 shows the slot IDs that are set and written with respect to each of the HDDs 41-1 through 41-15 within each device enclosure 3, for a case where 4 device enclosures 3 (DE00, DE01, DE02 and DE03) are connected to 1 RAID controller 2, and 15 HDDs 41-1 through 41-15 are inserted into corresponding slots SLOT00 through SLOT14 of each device enclosure 3. For the sake of convenience, it is assumed that the slot ID has 7 bits. The slot ID is made up of a 4-bit slot value and a 3-bit device enclosure ID. The slot value has a fixed value with respect to each of the HDDs 41-1 through 41-15 within each device enclosure 3, and forms the lower 4 bits of the slot ID. The device enclosure ID has a fixed value with respect to each device enclosure 3, and forms the upper 3 bits of the slot ID. For example, the slot ID of the first HDD 41-1 (SLOT00) from the left within the device enclosure DE00 (having a device enclosure ID “00”) is “0000000”, the slot ID of the second HDD 41-2 (SLOT01) from the left within the device enclosure DE00 is “0000001”, . . . , and the slot ID of the fifteenth HDD 41-15 (SLOT14) from the left within the device enclosure DE00 is “0001110”. The slot IDs are set similarly for the other device enclosures DE01, DE02 and DE03, as shown in FIG. 3.

By using the upper 3 bits within the 7 bits representing the slot ID of each HDD 41 to set the device enclosure ID that is unique to each device enclosure 3 when the power is turned ON, for example, and storing the device enclosure ID in the memory 302 within the MPU 301, it becomes possible to thereafter read the 7-bit slot ID of each HDD 41, obtain the AL_PA values by referring to tables which will be described later to set the AL_PA values in a fiber channel map FC-MAP, and access the HDD 41 requested by the access request that is received from the host unit via the RAID controller 2 based on the fiber channel map FC-MAP.

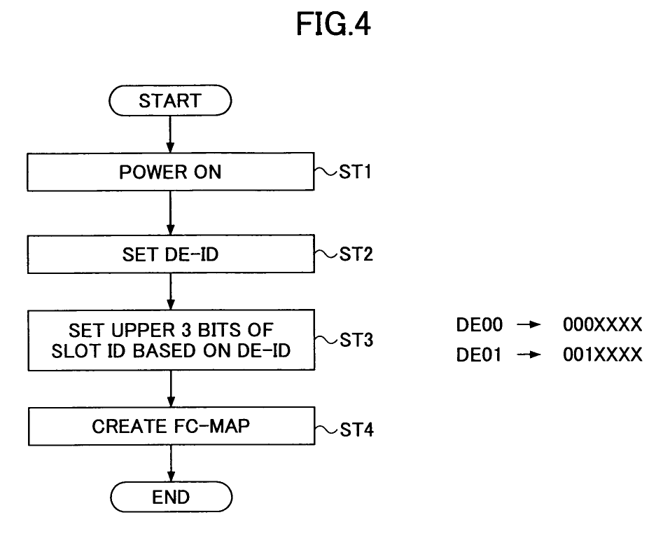

FIG. 4 is a flow chart for explaining an operation when setting the device enclosure ID. In FIG. 4, a step ST1 turns ON the power of the input and output apparatus. Hence, the power of the RAID controller 2 and the power of each device enclosure 3 shown in FIG. 1 are turned ON. A step ST2 sets and stores the device enclosure ID of each device enclosure 3 from the RAID controller 2 into the memory 302 within the MPU 301. A step ST3 sets the upper 3 bits of the slot ID by the MPU 301 within each device enclosure 3 based on the device enclosure ID. For example, “000” is set for the device enclosure 3 (DE00), and thus, the slot IDs are set in the following manner for each of the device enclosures 3, where the lower 4 bits “xxxx” of the slot IDs have an arbitrary value which is “0” or “1” and fixed for each HDD 41 (that is, a fixed value that is set in the register 34 within the back panel 32).

DE00→000xxxx

DE01→001xxxx

. . .

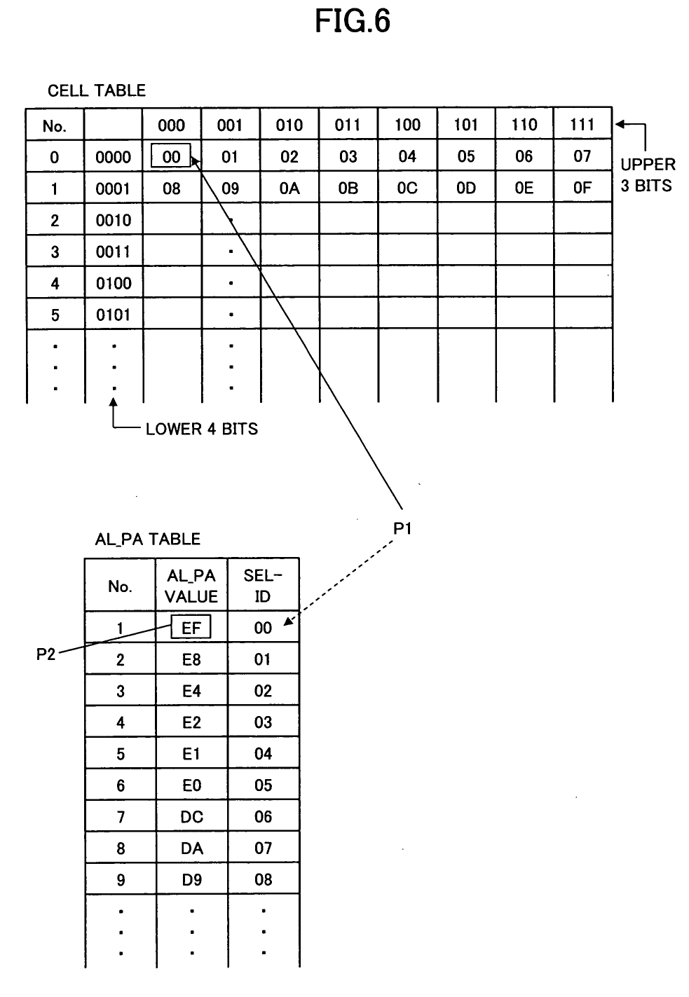

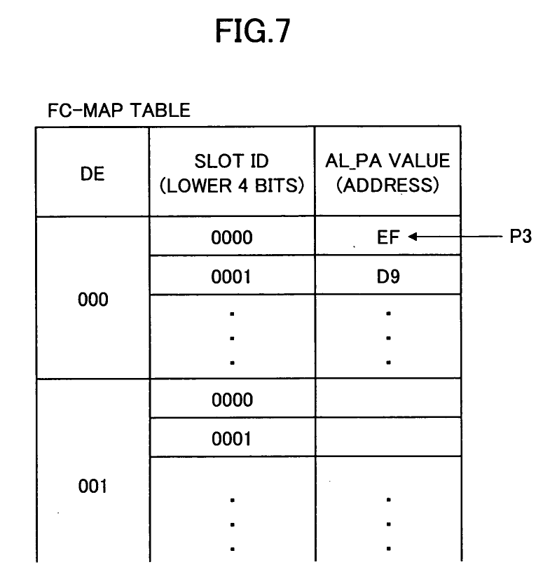

A step ST4 creates a table of fiber channel maps FC-MAP (hereinafter simply referred to as an FC-MAP table) shown in FIG. 7 by referring to a cell table and an AL_PA table shown in FIG. 6 which will be described later, by the MPU 301 within each device enclosure 3, based on the slot IDs that are set in the step ST3. FIG. 6 is a diagram for explaining the cell table and the AL_PA table, and FIG. 7 is a diagram for explaining the FC-MAP table. In addition, the step ST4 uses the AL_PA value acquiring function of the SW-CHIP 304 to calculate the AL_PA values, and writes the AL_PA values to the HDDs 41 written with the corresponding slot IDs.

Accordingly, after the value that is unique for each device enclosure 3 is set in the upper 3 bits of the 7-bit slot ID of each of the HDDs 41 within each device enclosure 3 when the power of the input and output apparatus 1 is turned ON, for example, it becomes possible to create the FC-MAP table shown in FIG. 7 by referring to the cell table and the AL_PA table shown in FIG. 6, based on the slot IDs (respectively having the device enclosure ID in the upper 3 bits and the slot value of the corresponding slot of the HDD 41 in the lower bits) of each of the HDDs 41.

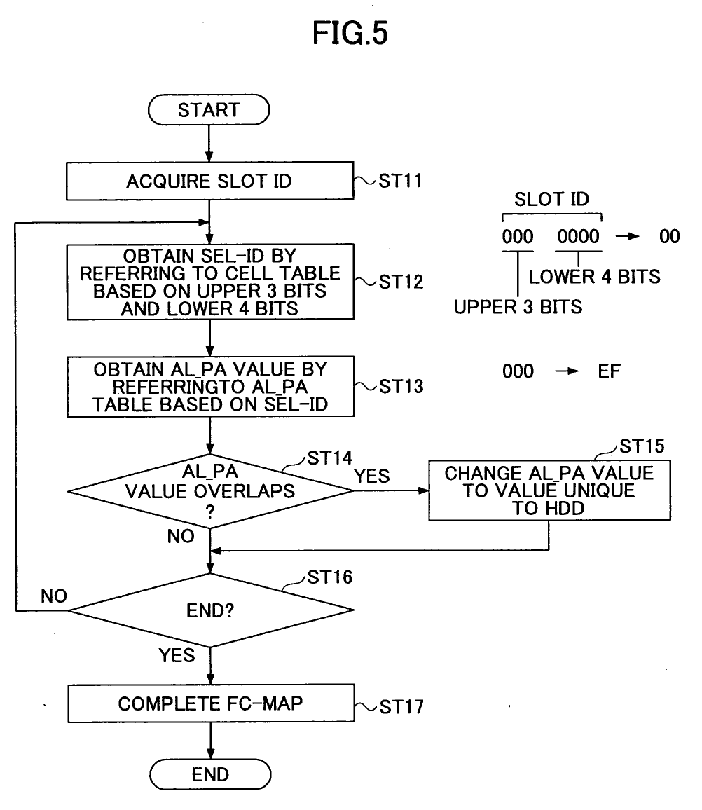

FIG. 5 is a flow chart for explaining an operation when creating the FC-MAP table in the step ST4 shown in FIG. 4. In FIG. 5, a step ST11 acquires the slot ID corresponding to the device enclosure 3 and the HDD 41. A step ST12 obtains (or calculates) a cell ID SEL-ID by referring to the cell table shown in FIG. 6 based on the upper 3 bits and the lower 4 bits of the slot ID. In the cell table shown in FIG. 6, the columns indicate the upper 3 bits forming the slot ID, the rows indicate the lower 4 bits forming the slot ID, and a value at an intersection of the column and row indicates the cell ID SEL-ID that is to be obtained. For example, if the step ST11 acquires the slot ID “0000000” from the first HDD41-1 from the left within the device enclosure DE00 shown in FIG. 2, a cell ID SEL-ID “00” indicated by P1 in FIG. 6 is obtained (or calculated) by referring to the cell table based on the upper 3 bits “000” and the lower 4 bits “0000” of the slot ID.

A step ST13 uses the AL_PA value acquiring function of the SW-CHIP 304, and obtains (or calculates) the corresponding AL_PA value by referring to the AL_PA table shown in FIG. 6 based on the cell ID SEL-ID. In the AL_PA table shown in FIG. 6, “SEL-ID” indicates the cell ID SEL-ID that is obtained by the cell table shown in FIG. 6, and the AL_PA value indicates an AL_PA (physical position or address of the HDD 41) that is to be obtained (or calculated). For example, an AL_PA value “EF” indicated by P2 in FIG. 6 is obtained (or calculated) by referring to the AL_PA table based on the cell ID SEL-ID “00” that is obtained by the step ST12.

A step ST14 decides whether or not an overlap of the AL_PA value exists. In other words, the step ST14 decides whether or not the AL_PA value obtained in the step ST13 overlaps (or coincides) with the AL_PA value that is obtained with respect to another HDD 41 within the same device enclosure 3. If the decision result in the step ST14 is YES, there is an overlap of the AL_PA value, and thus, a step ST15 changes the AL_PA value to an AL_PA value unique to the corresponding HDD 41, and the process advances to a step ST16. On the other hand, if the decision result in the step ST14 is NO, the process advances directly to the step ST16.

The step ST16 decides whether or not the steps ST11 through ST15 have been carried out with respect to the slot IDs of all of the HDDs 41 within the device enclosure 3 (DE00). If the decision result in the step ST16 is YES, a step ST17 creates the FC-MAP table shown in FIG. 7, writes the AL_PA value obtained in the above described manner to the HDD 41 that is written with the corresponding slot ID, and the process ends. The AL_PA values corresponding to each of the slot IDs are set with respect to each device enclosure 3 in the FC-MAP table shown in FIG. 7. In other words, the AL_PA values that are obtained (or calculated) by referring to the cell table and the AL_PA table shown in FIG. 6 are set in the FC-MAP table in correspondence with the device enclosure ID (upper 3 bits of the slot ID) and the slot value (lower 4 bits of the slot ID and corresponding to the slot value that is unique to each slot into which the HDD 41 is inserted). For example, with respect to the device enclosure 3 (DE00) having the slot ID with the upper 3 bits that are “000”, the AL_PA value “EF” that is obtained in the step ST13 (or changed in the step ST15) is set for the case where the lower 4 bits of the slot ID are “0000”. The FC-MAP table that is created using the cell table and the AL_PA table forms a table of the AL_PA map, and is stored in the memory 302 within the MPU 301 together with the cell table and the AL_PA table.

Therefore, it is possible to obtain (or calculate) the AL_PA value from the cell table and the AL_PA table shown in FIG. 6 based on the slot ID (made up of upper 3 bit and lower 4 bits) acquired from the HDD 41, and set the AL_PA value in the FC-MAP table shown in FIG. 7. When the access request is received from the host unit, it is possible to access the requested HDD 41 based on the AL_PA value of the HDD 41 (physical position or address of the HDD 41) by referring to the FC-MAP table shown in FIG. 7.

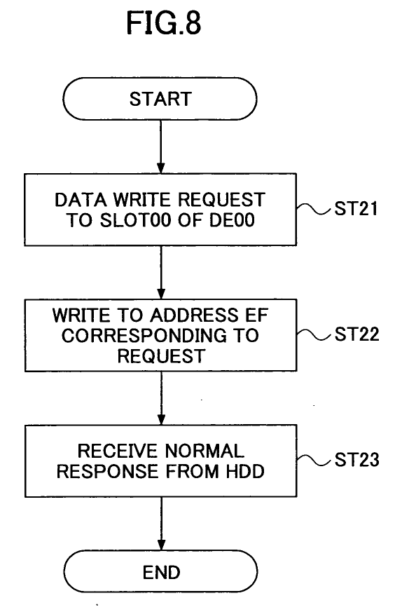

FIG. 8 is a flow chart for explaining a normal access operation. The access operation shown in FIG. 8 is carried out after the power of the input and output apparatus 1 is turned ON to start the input and output apparatus 1 and the input and output apparatus 1 assumes a ready state capable of operation. In a step ST21 shown in FIG. 8, the RAID controller 2 makes a data write request with respect to the device enclosure 3, that is, with respect to the slot SLOT00 of the device enclosure DE00 indicated by the slot ID, for example, in response to an access request (data write request) from the host unit. In a step ST22, the MPU 301 within the device enclosure 3 writes the data at the address “EF” corresponding to the slot ID of the data write request. In other words, in the step ST22, the AL_PA value acquiring function of the SW-CHIP 304 is used to obtain the AL_PA value “EF” indicated by P3 by referring to the FC-MAP table shown in FIG. 7 with respect to the slot ID (slot SLOT00 of the device enclosure DE00) of the data write request, and the data is written to the HDD 41 (HDD 41-1 in this case) that is written with this AL_PA value, that is, written to the address “EF”. When the MPU 301 receives, in a step ST23, a normal response from the HDD 41 to which the data is written, and the process ends.

Accordingly, when the RAID controller 2 receives from the host unit the access request specifying the slot SLOT00 of the device enclosure DE00 or the like, it is possible to access the requested HDD 41 by referring to the FC-MAP table shown in FIG. 7 and using the corresponding AL_PA value as the address.

Next, a description will be given of a slot ID diagnosis operation. The slot ID diagnosis operation may be realized by a self-diagnosis carried out in each device enclosure 3 or, by an apparatus diagnosis carried out by the RAID controller 2.

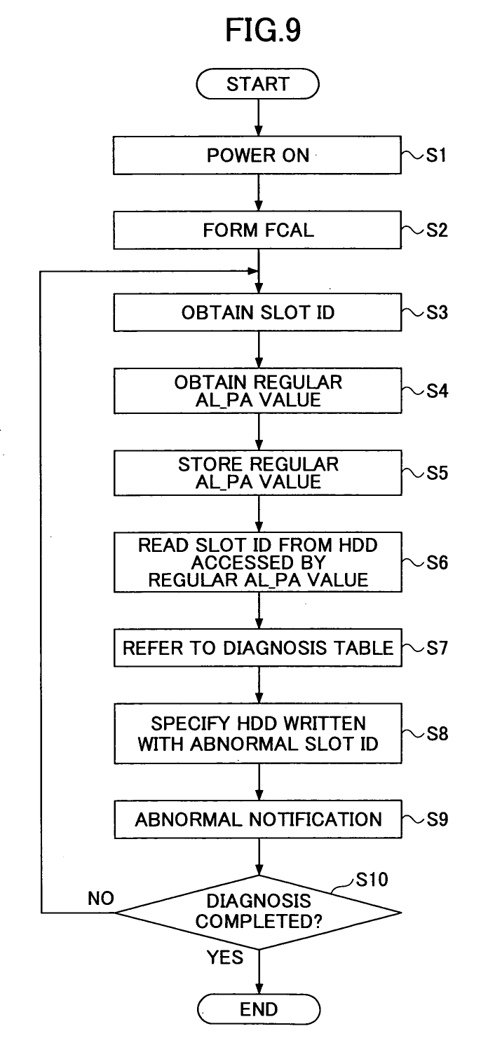

FIG. 9 is a flow chart for explaining a diagnosis operation carried out by the device enclosure 3. The diagnosis operation shown in FIG. 9 is carried out in a state where the operation of setting the device enclosure ID shown in FIG. 4, that is, the operation of creating the FC-MAP table shown in FIG. 5, is completed, and from a time when the power of the input and output apparatus 1 is turned ON until a time when the input and output apparatus 1 is started and assumes the ready state capable of operation.

The diagnosis operation shown in FIG. 9 is carried out within each device enclosure 3. In a step S1 shown in FIG. 9, the MPU 301 receives a power ON command from the RAID controller 2, and turns ON the power of the corresponding device enclosure 3. In a step S2, the MPU 301 bypasses an external Fiber Channel (FC) port of the SW-CHIP 304 (port connecting to the Fiber Channel Interface (FCI) that connects the SW-CHIP 304 to the RAID controller 2), and forms a closed CFAL within the corresponding device enclosure 3. In a step S3, the MPU 301 obtains the slot IDs with respect to each of the HDDs 41-1 through 41-N that are implemented in the corresponding device enclosure 3, based on the device enclosure ID and the slot values that are set for each of the slots. The device enclosure ID and the slot values used in the step S3 are prestored in the memory 302 within the MPU 301, and thus, the slot IDs obtained in the step S3 are regular (correct) slot IDs.

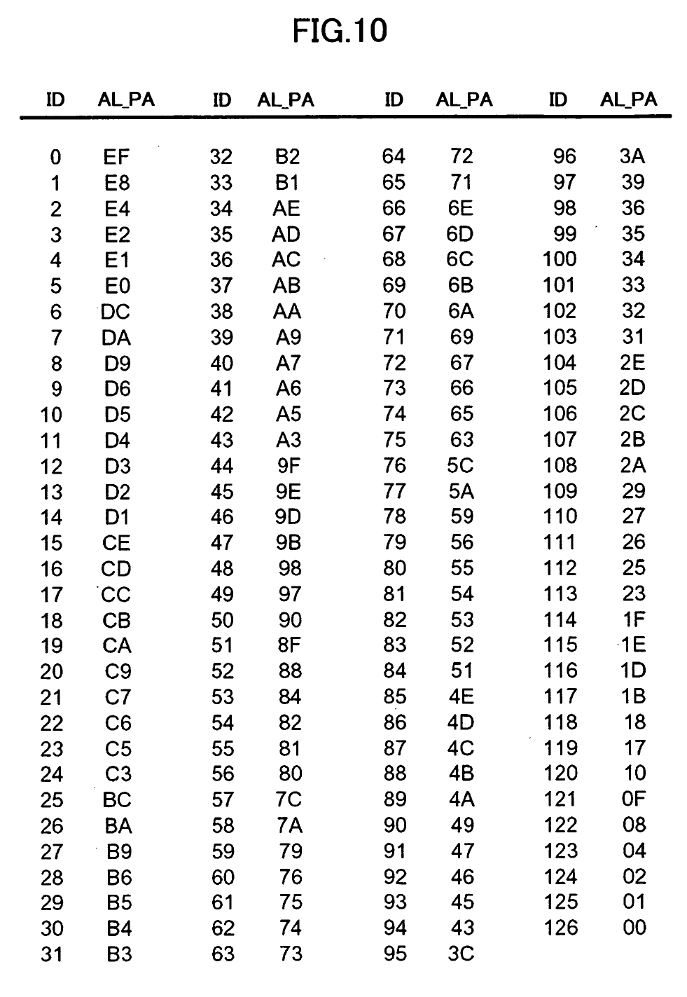

In a step S4, the MPU 301 obtains (or calculates) the regular AL_PA value of each of the HDDs 41-1 through 41-N that are implemented in the corresponding device enclosure 3 by using the AL_PA acquiring function of the SW-CHIP 304, based on the regular slot IDs obtained in the step S3. The regular AL_PA value may be calculated based on a predetermined algorithm or, obtained using the tables described above in conjunction with FIG. 6. For example, in a case where the device enclosure ID is represented by a SCSI ID, the regular AL_PA value of each of the HDDs 41-1 through 41-N implemented in the corresponding device enclosure 3 may be obtained using an AL_PA value calculation table shown in FIG. 10. FIG. 10 is a diagram showing the AL_PA value calculation table. In FIG. 10, “ID” indicates the SCSI ID, and “ALPA” indicates the AP_PA value. In a step S5, the MPU 301 stores the obtained regular AL_PA values in the memory 302.

In a step S6, the MPU 301 issues a command to each of the HDDs 41-1 through 41-N via the SW-CHIP 304 and the Fiber Channel Interface (FCI) using a SCSI Enclosure Service (SES) command, and reads the slot IDs from each of the HDDs 41-1 through 41-N that are accessed by each of the regular AL_PA values stored in the memory 302. In a step S7, the MPU 301 refers to a diagnosis table similar to the FC-MAP table shown in FIG. 7 by using each of the AL_PA values and the slot IDs read from each of the HDDs 41-1 through 41-N. In a step S8, the MPU 301 specifies the HDD 41 in which the slot ID is not correctly written (that is, written with an abnormal slot ID) using the diagnosis table. For example, if the slot ID “0000000” is read from the HDD 41 that is written with the AL_PA value for the case where the slot ID is “0000000”, the pair of corresponding slot ID and AL_PA value is stored in the diagnosis table, and it is possible to confirm that the slot ID of the HDD 41 (HDD 41-1 in this case) is correctly written and the HDD 41-1 is inserted in a normal manner into the slot having the slot value “0000”. On the other hand, if the slot ID “0000001” is read from the HDD 41 that is written with the AL_PA value for the case where the slot ID is “0000000”, the pair of corresponding slot ID and AL_PA value is not stored in the diagnosis table, and it is possible to confirm that the slot ID of the HDD 41 (HDD 41-1 in this case) is not correctly written and the HDD 41-1 is not inserted in a normal manner into the slot having the slot value “0000”. In addition, if the HDD 41 that is written with the AL_PA value for the case where the slot ID is “0000000” does not exist and the slot ID cannot be read, the correct AL_PA value is not written in the HDD 41-1 that is inserted into the slot having the slot value “0000”, and it is possible to confirm that the HDD 41-1 is not inserted in a normal manner into the slot having the slot value “0000”.

In a step S9, the HDD 41 that has been confirmed by the MPU 301 as not being inserted in a normal manner into the corresponding slot is disconnected from the corresponding device enclosure 3, and the MPU 301 notifies the abnormality specified in the step S8 to the RAID controller 2 via the control interface. In a step S10, the MPU 301 decides whether or not the diagnosis has been completed with respect to all of the HDDs 41-1 through 41-N within the corresponding device enclosure 3. The process returns to the step S3 if the decision result in the step S10 is NO. But if the decision result in the step S10 is YES, the external port that was bypassed last is restored and the process ends.

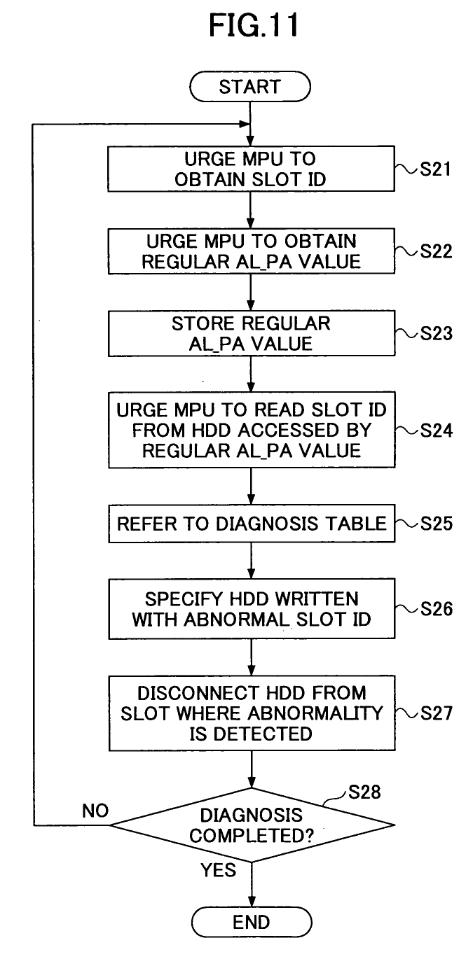

FIG. 11 is a flow chart for explaining a diagnosis operation carried out by the RAID controller 2. The diagnosis operation shown in FIG. 11 is carried out in a state where the operation of setting the device enclosure ID shown in FIG. 4, that is, the operation of creating the FC-MAP table shown in FIG. 5, is completed, and from the time when the power of the input and output apparatus 1 is turned ON until the time when the input and output apparatus 1 is started and assumes the ready state capable of operation.

The diagnosis operation shown in FIG. 11 is carried out within the RAID controller 2. In a step S21 shown in FIG. 11, the RAID controller 2 causes the MPU 301 within the corresponding device enclosure 3 to obtain the slot IDs with respect to each of the HDDs 41-1 through 41-N that are implemented in the corresponding device enclosure 3, based on the device enclosure ID and the slot values that are set for each of the slots. The device enclosure ID and the slot values used in the step S21 are prestored in the memory 302 within the MPU 301, and thus, the slot IDs obtained in the step S21 are regular (correct) slot IDs.

In a step S22, the RAID controller 2 causes the MPU 301 within the corresponding device enclosure 3 to obtain (or calculate) the regular AL_PA value of each of the HDDs 41-1 through 41-N that are implemented in the corresponding device enclosure 3 by using the AL_PA acquiring function of the SW-CHIP 304, based on the regular slot IDs obtained in the step S21. The regular AL_PA value may be calculated based on a predetermined algorithm or, obtained using the tables described above in conjunction with FIG. 6. For example, in a case where the device enclosure ID is represented by a SCSI ID, the regular AL_PA value of each of the HDDs 41-1 through 41-N implemented in the corresponding device enclosure 3 may be obtained using the AL_PA value calculation table shown in FIG. 10. In a step S23, the RAID controller 2 is notified of the regular AL_PA values obtained in the MPU 301, from the MPU 301, and stores the regular AL_PA values in a memory within the RAID controller 2.

In a step S24, the RAID controller 2 causes the MPU 301 to issue a command to each of the HDDs 41-1 through 41-N via the SW-CHIP 304 and the Fiber Channel Interface (FCI) using a SCSI Enclosure Service (SES) command, and to read the slot IDs from each of the HDDs 41-1 through 41-N that are accessed by each of the regular AL_PA values stored in the memory within the RAID controller 2. In a step S25, the RAID controller 2 refers to a diagnosis table similar to the FC-MAP table shown in FIG. 7 and stored in the memory within the RAID controller 2, by using each of the AL_PA values and the slot IDs read from each of the HDDs 41-1 through 41-N. In a step S26, the RAID controller 2 specifies the HDD 41 in which the slot ID is not correctly written (that is, written with an abnormal slot ID) using the diagnosis table. For example, if the slot ID “0000000” is read from the HDD 41 that is written with the AL_PA value for the case where the slot ID is “0000000”, the pair of corresponding slot ID and AL_PA value is stored in the diagnosis table, and it is possible to confirm that the slot ID of the HDD 41 (HDD 41-1 in this case) is correctly written and the HDD 41-1 is inserted in a normal manner into the slot having the slot value “0000”. On the other hand, if the slot ID “0000001” is read from the HDD 41 that is written with the AL_PA value for the case where the slot ID is “0000000”, the pair of corresponding slot ID and AL_PA value is not stored in the diagnosis table, and it is possible to confirm that the slot ID of the HDD 41 (HDD 41-1 in this case) is not correctly written and the HDD 41-1 is not inserted in a normal manner into the slot having the slot value “0000”. In addition, if the HDD 41 that is written with the AL_PA value for the case where the slot ID is “0000000” does not exist and the slot ID cannot be read, the correct AL_PA value is not written in the HDD 41-1 that is inserted into the slot having the slot value “0000”, and it is possible to confirm that the HDD 41-1 is not inserted in a normal manner into the slot having the slot value “0000”.

In a step S27, the HDD 41 that has been confirmed by the RAID controller 2 as not being inserted in a normal manner into the corresponding slot is disconnected from the corresponding device enclosure 3. In a step S28, the RAID controller 2 decides whether or not the diagnosis has been completed with respect to all of the HDDs 41-1 through 41-N within the corresponding device enclosure 3 and the diagnosis has been completed with respect to all of the device enclosures 3 within the input and output apparatus 1. The process returns to the step S21 if the decision result in the step S28 is NO. But if the decision result in the step S28 is YES, the process ends.

Therefore, when an abnormal slot ID is detected by the diagnosis operation of the device enclosure 3 or the RAID controller 2, the HDD 41 written with the abnormal slot ID is disconnected from the slot in the back panel 32 of the corresponding device enclosure 3, and the starting of the input and output apparatus 1 is completed thereafter. Since the HDD 41 implemented in each device enclosure 3 and written with the abnormal slot ID is disconnected from the corresponding device enclosure 3 before the starting of the input and output apparatus 1 is completed, the abnormality of the slot ID is not visible from the RAID controller 2.

Of course, at least a portion of the various kinds of tables, the slot values, the device enclosure IDs and the AL_PA values may be stored in a memory within the SW-CHIP 304, instead of within the memory 302 within the MPU 301.

Therefore, the present invention is suited for use in an input and output apparatus which uses a large number of storage units such as HDDs, when specifying the storage unit such as the HDD from which an erroneous slot value is read.

This application claims the benefit of a Japanese Patent Application No.2005-039469 filed Feb. 16, 2005, in the Japanese Patent Office, the disclosure of which is hereby incorporated by reference.

Further, the present invention is not limited to these embodiments, but various variations and modifications may be made without departing from the scope of the present invention.

What is claimed is:

1. An identification information diagnosis method for an input and output apparatus in which first identification information unique to each of storage units is written in each of the storage units that is inserted into a corresponding one of slots of each of device enclosures, and a physical address of each of the storage units is obtained from second identification information unique to each of the device enclosures and the first identification information that is read from each of the storage units of a corresponding one of the device enclosures and stored in the corresponding one of the storage units, said identification information diagnosis method comprising the steps of:
(a) obtaining a regular physical address from first and second identification information prestored in a memory;
(b) reading the first identification information from one of the storage units that is accessed by the regular physical address; and
(c) diagnosing the first identification information read from said one of the storage units that is accessed by the regular physical address, based on a diagnosis table that stores the regular physical address and a corresponding regular first identification information.

2. The identification information diagnosis method as claimed in claim 1, wherein said step (c) confirms an abnormality of a storage unit that is inserted in a slot having the first identification information that takes a predetermined value, if the first identification information cannot be read from the storage unit that is accessed by the regular physical address for a case where the first identification information takes the predetermined value.

3. The identification information diagnosis method as claimed in claim 1, wherein said step (c) confirms an abnormality of a storage unit that is inserted in a slot having the first identification information that takes a predetermined value, if the first identification information read from the storage unit that is accessed by the regular physical address for a case where the first identification information takes the predetermined value is not stored in the diagnosis table as the first identification information corresponding to the regular physical address for the case where the first identification information takes the predetermined value.

4. The identification information diagnosis method as claimed in claim 1, wherein said step (a) obtains the regular physical address by referring to a table based on the first and second identification information.

5. The identification information diagnosis method as claimed in claim 1, wherein each of the storage units is formed by a disk drive, the first and second identification information form a slot ID, and the physical address is an AL_PA value.

6. The identification information diagnosis method as claimed in claim 1, wherein said step (c) is carried out within each of the device enclosures.

7. The identification information diagnosis method as claimed in claim 1, wherein said step (c) is carried out within a controller that centrally controls each of the device enclosures.

8. An input and output apparatus in which first identification information unique to each of storage units is written in each of the storage units that is inserted into a corresponding one of slots of each of device enclosures, and a physical address of each of the storage units is obtained from second identification information unique to each of the device enclosures and the first identification information that is read from each of the storage units of a corresponding one of the device enclosures and stored in the corresponding one of the storage units, said input and output apparatus comprising:
an obtaining part configured to obtain a regular physical address from first and second identification information prestored in a memory;
a reading part configured to read the first identification information from one of the storage units that is accessed by the regular physical address; and
a diagnosing part configured to diagnose the first identification information read from said one of the storage units that is accessed by the regular physical address, based on a diagnosis table that stores the regular physical address and a corresponding regular first identification information.

9. The input and output apparatus as claimed in claim 8, wherein said diagnosing part confirms an abnormality of a storage unit that is inserted in a slot having the first identification information that takes a predetermined value, if the first identification information cannot be read from the storage unit that is accessed by the regular physical address for a case where the first identification information takes the predetermined value.

10. The input and output apparatus as claimed in claim 8, wherein said diagnosing part confirms an abnormality of a storage unit that is inserted in a slot having the first identification information that takes a predetermined value, if the first identification information read from the storage unit that is accessed by the regular physical address for a case where the first identification information takes the predetermined value is not stored in the diagnosis table as the first identification information corresponding to the regular physical address for the case where the first identification information takes the predetermined value.

11. The input and output apparatus as claimed in claim 8, wherein said obtaining part obtains the regular physical address by referring to a table based on the first and second identification information.

12. The input and output apparatus as claimed in claim 8, wherein each of the storage units is formed by a disk drive, the first and second identification information form a slot ID, and the physical address is an AL_PA value.

13. The input and output apparatus as claimed in claim 8, wherein said diagnosing part is provided within each of the device enclosures.

14. The input and output apparatus as claimed in claim 8, further comprising:
a controller configured to centrally control each of the device enclosures,
wherein said diagnosing part is provided within said controller.
